(19) United States
(12) Patent Application Publication
(10) Pub. No.: US 2008/0276481 A1
(43) Pub. Date: Nov. 13, 2008

(54) Elastic storage compartment

(76) Inventor: Kathryn K. Mizereck, Tallahassee, FL (US)

Correspondence Address: Pennington, Moore, Wilkinson. Bell & Dunbar, P.A., 215 S. Monroe Street, 2nd Floor, Post Office Box 10095, Tallahassee, FL, 32301, US

(21) Appl. No.: 12/218,701

(22) Filed: Jul. 17, 2008

Related U.S. Application Data
(62) Division of application No. 11/302,053, filed on Dec. 13, 2005.

(51) Int. Cl. F26B 5/00

(52) U.S. Cl. 34/282

(57) ABSTRACT

An elastic storage compartment for holding objects, such as objects used in swimming pools, against a wall or other surface. The storage compartment generally includes a frame with a left member, a right member, and a bottom member where the bottom member connects the right and left members. An adjustable tie line attaches and runs between the top end of the left and right members. The tie line and frame together form a substantially rectangular perimeter, and an elastic net attaches to the tie line and frame and spans the interior of the perimeter. In the preferred embodiment, grommets are attached to the frame, so that the frame can be attached to the wall or other surface with ties. The storage compartment forms a “pocket” against the wall, so that the user may insert objects into the opening between the tie line and the wall, thereby trapping the objects between the wall and elastic net. An optional spring cinch may be provided on the tie line so that the pocket opening may be loosened to receive larger objects and then tightened to secure the objects in the “pocket.”

### CROSS-REFERENCES TO RELATED APPLICATIONS

This application is a divisional application of U.S. application Ser. No. 11/302,053.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of storage devices. More specifically, the present invention comprises an elastic storage compartment which may be used to hold and store objects against fences and walls.

2. Description of the Related Art

Various storage devices exist for storing inflatable toys and other objects used in swimming pools. Conventional examples of these storage devices include plastic and wooden storage boxes and bins. There are many complications, however, involved with the storage of these types of objects in conventional storage compartments. For example, many of the objects to be stored are bulky and unconventional in shape. Most conventional storage devices, on the other hand, are rigid and conventional in shape. Accordingly, a user typically must use a storage device that is substantially larger than the object or, if possible, deflate the object prior to storage.

In addition, objects that are used in swimming pools often mold or mildew when left in closed compartments. It is often impractical for the user to dry the objects before placing them in a storage compartment. Drying the objects byhand can be tedious and time consuming. Furthermore, even the slightest amount of moisture left on the object may produce mold, so hand drying the objects is usually ineffective.

For people who use more than one storage compartment to hold these objects, finding a particular object among the various compartments can be cumbersome. In such a situation where one employs multiple storage compartments, one may often have to open many different compartments and sort through the contents of each compartment before locating the object that is sought.

Although these complications are particularly relevant to the storage of objects which are used in swimming pools, some of these complications are also common in other storage applications. Accordingly, it would be desirable to have a storage compartment that can hold objects of various sizes and shapes and will inhibit the growth of mold and mildew. Furthermore, it would be desirable for a storage compartment to be configured to allow the user to easily locate a particular object that is stored in the compartment.

### BRIEF SUMMARY OF THE PRESENT INVENTION

The present invention comprises an elastic storage compartment for holding objects, such as objects used in swimming pools, against a wall or other surface. The storage compartment generally includes a frame with a left member, a right member, and a bottom member connecting the right and left members. An adjustable tie line attaches and runs between the top end of the left and right members. The tie line and frame together form a substantially rectangular perimeter, and an elastic net attaches to the tie line and frame and spans the interior of the perimeter. In the preferred embodiment, grommets are attached to the frame, so that the frame can be attached to the wall or other surface with ties. The storage compartment forms a “pocket” against the wall, so that the user may insert objects into the opening between the tie line and the wall, thereby trapping the objects between the wall and elastic net. An optional spring cinch may be provided on the tie line so that the pocket opening may be loosened to receive larger objects and then tightened to secure the objects in the “pocket.”

### BRIEF DESCRIPTION OF THE SEVERAL VIEWS OF THE DRAWINGS

FIG. 1 is a perspective view, showing the present invention.

FIG. 2 is a perspective view, showing the present invention attached to a fence.

FIG. 3 is a perspective view, showing the present invention in use.

REFERENCE NUMERALS IN THE DRAWINGS

| | | | |
|---|---|---|---|
| 10 | elastic storage compartment | 12 | frame |
| 14 | tie line | 16 | net |
| 18 | cinch | 20 | grommets |
| 22 | draw string | 24 | fence |
| 26 | pocket | 28 | ties |
| 30 | ball | 32 | float toy |

### DETAILED DESCRIPTION OF THE INVENTION

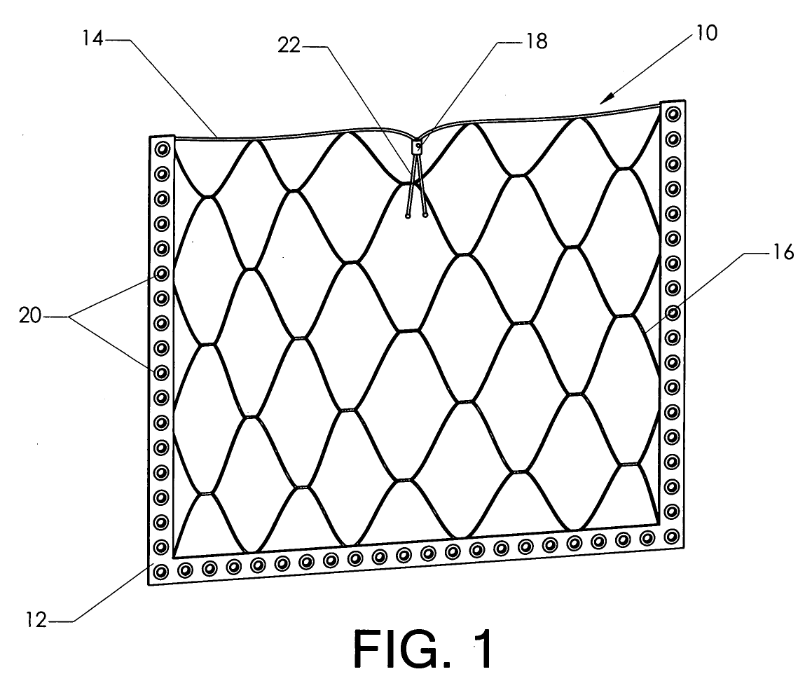

The present invention, elastic storage compartment 10, is shown in FIG. 1. Elastic storage compartment 10 generally includes frame 12, tie line 14, and net 16. In the preferred embodiment, frame 12 has a left member, a right member, and a bottom member which connects the left and right members. These terms are dependent upon the orientation shown in the view. Generally, they may be called a first side member, a second side member, and a bridging member therebetween. Tie line 14 attaches to the top ends of the left and right members, so that the tie line and the frame together form a rectangular perimeter. Net 16 is attached to frame 12 and tie line 14 and spans the interior of the perimeter formed by frame 12 and tie line 14.

Frame 12 can be made of any material. In the preferred embodiment, frame 12 is made of a strip of a nylon-weave fabric or some other material that is suitable for long-term outdoor use. Grommets 20 are attached around frame 12 to facilitate attachment of elastic storage compartment 10 to the wall. Although grommets 20 are illustrated in FIG. 1, other attachment means can be used including but not limited to nails, screws, snaps, and tie strings.

Net 16 is preferably made of a relatively loose weave of nylon cords or other material so that net 16 may expand easily to accommodate large items. In the preferred embodiment, each cord is highly elastic and can double in length or more. As shown in FIG. 1, a series of cords can be attached to the left member of frame 12 and the right member of frame 12 and woven loosely between tie line 14 and the bottom member of frame 12. Although this configuration is preferred, the reader will appreciate that other materials and configurations can also be used. For example, net 16 may also be made of mesh. It is generally preferred, however, to use a material that has large enough openings to allow water to easily escape. Large openings also allow air to easily circulate around objects that are stored in elastic storage compartment 10. Employing such a material also enables the user to more quickly locate objects that are stored in elastic storage compartment 10, since the contents can be easily seen.

In addition, cinch 18 may be employed on tie line 14 so that tie line 14 may be loosened to allow larger objects to easily be inserted between net 16 and the wall. Cinch 18 is preferably a conventional spring-biased cinch which is configured to cinch tie line 14 when the push button of cinch 18 is in the unpushed position. To loosen tie line 14, the user simply pushes the button on cinch 18 and pulls cinch 18 away from the wall. To tighten tie line 14, the user pushes the button on cinch 18, pulls draw string 22 while pushing cinch 18 toward the wall, and then releases the button.

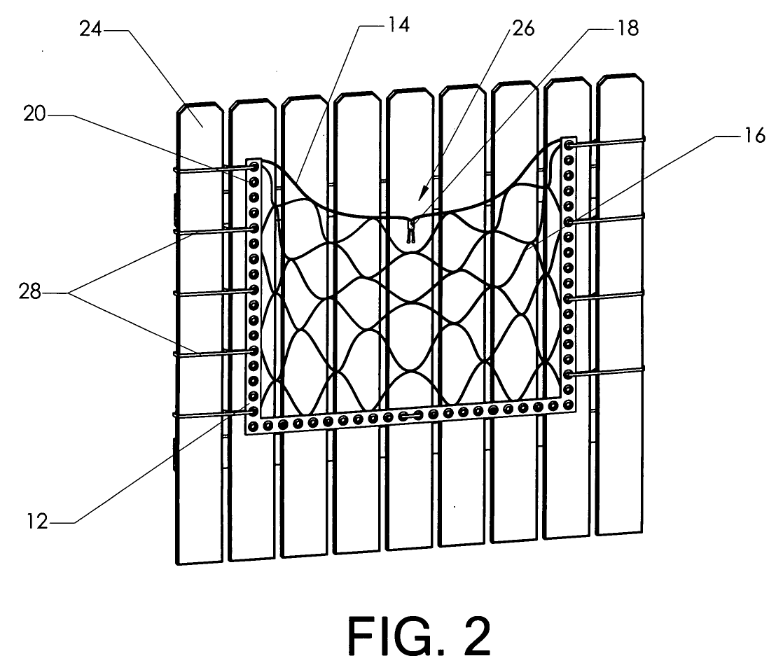

The present invention is shown attached to a wall in FIG. 2. In this illustration, elastic storage compartment 10 is attached to fence 24 with ties 28. Ties 28 may simply be strands of rope or string which are wrapped through at least one grommet 20. Rope and string are effective when attaching elastic storage compartment 10 to a fence, because the rope or string may be wrapped through grommet 20 and then tied around one of the boards in the fence as shown. The same is true if the device is to be attached to a chain-link fence except that the rope or string is tied through one of the links in the chain instead of around a board. If the device is to be attached to a solid wall, screws, nails, hooks or other suitable attachment means may also be used.

Tie line 14 is depicted in the loosened position in FIG. 2 as would be common before objects are placed behind net 16. The reader will appreciate that pocket 26 is formed between net 16 and fence 24 with an opening between tie line 14 and fence 24. Although elastic storage compartment 10 is shown with the pocket facing up, the reader will appreciate that the device may be rotated 90 degrees or 180 degrees so that the pocket faces to the side or bottom respectively.

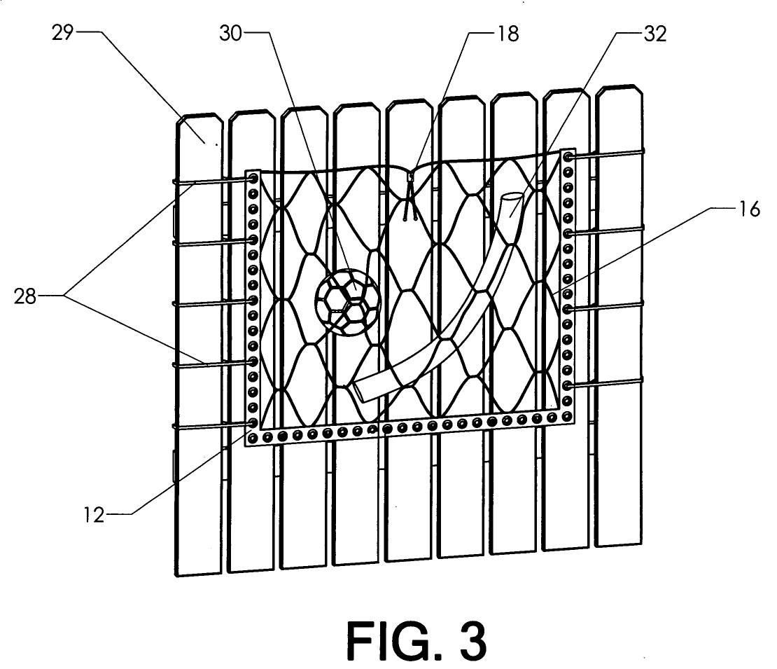

The present invention is shown in use in FIG. 3. Ball 30 and float toy 32 are inserted into pocket 26, and then cinch 18 is used to tighten tie line 14 causing ball 30 and float toy 32 to become securely trapped between net 16 and fence 24. The reader will appreciate that it is easy to see what objects are stored in elastic storage compartment 10 so that time is not needlessly wasted searching for objects which are not stored in the compartment. Because a loose weave pattern is used for net 16, both large and small objects can easily be stored in the compartment.

Although the preceding descriptions contain significant detail they should not be viewed as limiting the invention but rather as providing examples of the preferred embodiments of the invention. For example, other attaching means aside from grommet 20 can be used for attaching elastic storage compartment 10 to the wall or other surface (including nails, screws, nylon wire ties, bungee cords, etc.). In addition, elastic storage compartment 10 can also be made into non-rectangular shapes. These variations do not depart from the spirit and scope of the present invention. Accordingly, the scope of the invention should be determined by the following claims, rather than the examples given.

Having described my invention, I claim:

1. A method for drying an object comprising:
a. providing an air permeable surface;
b. providing a storage compartment further comprising:
i. a frame having a first side member, a second side member, a bridging member connected therebetween, and an open side;
ii. an elastic material attached to said first side member of said frame, said second side member of said frame, and said bridging member of said frame;
iii. a detachable attachment device for attaching said frame to said air permeable surface, said detachable attachment device configured to allow said frame to be detachably attached to said air permeable surface at a user-selectable location and repositioned on said air permeable surface when desired;
c. attaching said storage compartment to said air permeable surface such that a pocket is formed;
d. separating said top of said storage compartment from said air permeable surface to open said pocket;
e. inserting said object between said storage compartment and said air permeable surface; and
f. releasing said storage compartment so that said object is restrained against said air permeable surface.

2. A method as recited in claim 1, further comprising:
a. connecting a tie line to said first side member of said frame and said second side member of said frame; and
b. adjusting said tie line by way of an adjustment device by tightening said opening of said pocket with respect to said air permeable surface and thereby securing said objects between and against said elastic material and said air permeable surface.

3. A method as recited in claim 1, wherein said object is held in place by compressing said object directly against said air permeable surface.

4. A method as recited in claim 1, wherein said air permeable surface is substantially flat and continuous.

5. A method as recited in claim 1, wherein said attachment device is a plurality of grommets attached to said frame.

6. A method as recited in claim 2, wherein said adjustment device is a cinch for adjusting the length of said tie line.

7. A method as recited in claim 1, wherein said attachment device is a plurality of ties.

8. A method as recited in claim 2, wherein said attachment device is a plurality of ties.

9. A method as recited in claim 1, wherein said attachment device is a plurality of bungee cords.

10. A method for drying an object comprising:
a. providing an air permeable surface;
b. providing a storage compartment further comprising:
i. a frame having a first side member, a second side member, a bridging member connected therebetween, and an open side;
ii. an elastic material attached to said first side member of said frame, said second side member of said frame, and said bridging member of said frame;
iii. an attachment device for attaching said frame to said air permeable surface;
iv. a tie line attached to and running between said first side member and said second side member proximal to said open side, so that said tie line, said first member, said second member, and said connecting member together form a substantially rectangular perimeter with an interior;
v. a material spanning said interior of said substantially rectangular perimeter, said material attached to said first side member, said second side member, said bridging member, and said tie line;
b. attaching said storage compartment to said air permeable surface such that a pocket is formed, said pocket having an opening;
c. separating said top of said storage compartment from said air permeable surface to open said pocket;
d. inserting said object between said storage compartment and said air permeable surface;
e. releasing said storage compartment so that said object is restrained against said air permeable surface; and
f. tightening said tie line to minimize said opening of said pocket.

11. A method as recited in claim 10, wherein said attachment device is a plurality of grommets attached to said frame.

12. A method as recited in claim 10, wherein said attachment device is a plurality of ties.

13. A method as recited in claim 10, wherein said attachment device is a plurality of bungee cords.

14. A method as recited in claim 10, further comprising compressing said object between said material spanning said interior of said substantially rectangular perimeter and said air permeable surface.

15. A method as recited in claim 10, further comprising adjusting the length said tie line by an adjustment device.

16. A method as recited in claim 15, wherein said adjusting device is a cinch.
